(19) United States
(12) Patent Application Publication
(10) Pub. No.: US 2015/0373500 A1
(43) Pub. Date: Dec. 24, 2015

(54) APPARATUS AND METHOD FOR MULTI-HYPOTHESIS LOCATION TESTING

(71) Applicant: QUALCOMM Incorporated, San Diego, CA (US)

(72) Inventors: Yin CHEN, Campbell, CA (US); Faraz MOHAMMAD MIRZAEI, San Jose, CA (US); Hui CHAO, San Jose, CA (US); Sameera PODURI, Santa Clara, CA (US)

(21) Appl. No.: 14/309,753

(22) Filed: Jun. 19, 2014

(51) Int. Cl. H04W 4/02; H04W 64/00; H04W 24/10; H04W 16/20

(52) U.S. Cl. CPC H04W 4/028; H04W 16/20; H04W 64/006; H04W 24/10; H04W 4/043

(57) ABSTRACT

Systems, apparatus and methods to perform hypothesis localization are presented. An access point (AP) is associated with one specific area, such as an LCI (location context identifier). Each specific area defines area information comprising an identifier, a list of APs, and a map of the specific area. Each specific area, and associated APs from the list of APs, is hypothesized as the specific area containing a mobile device. For each hypothesized area, a mobile device trajectory is formed using just listed APs from that area, to form a plurality of mobile device trajectories. After evaluating the resulting plurality of mobile device trajectories, a selection is made of the best fitting mobile device trajectory.

### BACKGROUND

I. Field of the Invention

This disclosure relates generally to systems, apparatus and methods for position or location determination of a mobile device, and more specifically for indoor localization based on multi-hypothesis testing using a plurality of mobile device trajectories.

II. Background

A location context identifier (LCI) is a uniquely identifiable area such as a single floor or a wing of a floor with a single floor map or floor plan. Within an LCI, indoor localization is performed, for example, using a particle filter. LCI disambiguation is the procedure to identify which LCI a mobile device is within so a proper map of the area and the correct assistance data may be downloaded from a server. Once the proper map and correct assistance data are downloaded, an indoor localization engine may start. A localization engine's particle filter uses one RSSI or RTT heatmap per access point (AP). An LCI may correspond to one single-floor building map represented by, for example, a connectivity grid.

Typically, a mobile device determines a current LCI and then requests and receives assistance data. The request may be several bytes but the assistance data may be several kilobytes to several megabytes. there exists a need to reduce data traffic between a mobile device and a server.

### BRIEF SUMMARY

Disclosed are systems, apparatus and methods to compute multiple hypotheses for an area identifier, for example, a current location context identifier (LCI). An area identifier, such as an LCI, defines a particular floor or a section of a floor. An access point (AP) is associated with one area identifier. Each mobile device trajectory is computed assuming the mobile device is located at one hypothesized area identifier and using the measurements of the list of APs belong to the one hypothesized area identifier. The current area identifier is based on the best trajectory of the mobile device.

According to some aspects, disclosed is a method to perform hypothesis localization, the method comprising: receiving, for a plurality of specific areas, area information, wherein for each specific area, the area information comprises an identifier, a list of access points (APs), and a map of the specific area; providing a plurality of mobile device trajectories, wherein each trajectory of the plurality of mobile device trajectories corresponds to the list of APs from a hypothesized area; evaluating the plurality of mobile device trajectories; and selecting an area identifier bases on evaluating the plurality of mobile device trajectories.

According to some aspects, disclosed is a device to perform hypothesis localization, the device comprising: a receiver configured to receive, for a plurality of specific areas, area information, wherein for each specific area, the area information comprises an identifier, a list of access points (APs), and a map of the specific area; and a processor coupled to the receiver, wherein the processor is configured to: provide a plurality of mobile device trajectories, wherein each trajectory of the plurality of mobile device trajectories corresponds to the list of APs from a hypothesized area; evaluate the plurality of mobile device trajectories; and select an area identifier bases on evaluating the plurality of mobile device trajectories.

According to some aspects, disclosed is a device to perform hypothesis localization, the device comprising: means for receiving, for a plurality of specific areas, area information, wherein for each specific area, the area information comprises an identifier, a list of access points (APs), and a map of the specific area; means for providing a plurality of mobile device trajectories, wherein each trajectory of the plurality of mobile device trajectories corresponds to the list of APs from a hypothesized area; means for evaluating the plurality of mobile device trajectories; and means for selecting an area identifier bases on evaluating the plurality of mobile device trajectories.

According to some aspects, disclosed is a non-transient computer-readable storage medium, for a device to perform hypothesis localization, including program code stored thereon, comprising program code to: receive, for a plurality of specific areas, area information, wherein for each specific area, the area information comprises an identifier, a list of access points (APs), and a map of the specific area; provide a plurality of mobile device trajectories, wherein each trajectory of the plurality of mobile device trajectories corresponds to the list of APs from a hypothesized area; evaluate the plurality of mobile device trajectories; and select an area identifier bases on evaluating the plurality of mobile device trajectories.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Some embodiments of the invention will be described, by way of example only, with reference to the drawings.

FIG. 1 shows a thread diagram to convert a rough location into a plurality of mobile device trajectories, in accordance with some embodiments.

FIG. 2 shows a thread diagram to request assistance data.

FIG. 3 shows a thread diagram to convert a plurality of mobile device trajectories into an area identifier, in accordance with some embodiments.

FIG. 4 shows a structure of a table of area information, in accordance with some embodiments.

FIG. 5 illustrates a method in a mobile device to obtain a plurality of mobile device trajectories, in accordance with some embodiments.

FIG. 6 illustrates a method in a mobile device to convert a plurality of mobile device trajectories into an area identifier, in accordance with some embodiments.

FIG. 7 illustrates a method in a server to deliver a table of area information, in accordance with some embodiments.

FIG. 8 illustrates a method in a server to convert a plurality of mobile device trajectories into an area identifier, in accordance with some embodiments.

FIG. 9 shows a thread diagram to convert a plurality of mobile device trajectories into an area identifier, in accordance with some embodiments.

FIGS. 10-13 compare two trajectories to a reference, in accordance with some embodiments.

FIG. 14 charts hypotheses of various power measurements, in accordance with some embodiments.

FIG. 15 shows a thread diagram to request assistance data, in accordance with some embodiments.

FIGS. 16 and 17 show a block diagram of a mobile device and a server, respectively, in accordance with some embodiments.

FIG. 18 shows a thread diagram, in accordance with some embodiments.

FIG. 19-21 show where a mobile device and/or a server perform methods described herein, in accordance with some embodiments.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

In one particular implementation, a request for indoor navigation assistance data from a mobile device may specify an identifier, such as an LCI (location context identifier), to identify a specific area of a plurality of specific areas. The identity (ID) may be associated with a locally defined area such as, for example, a particular floor of a building or other indoor area that is not mapped according to a global coordinate system. In one example, upon entry of a specific area, a mobile device may request from a server, such as a location server, to provide area information covering just one specific area, or area information covering both the specific area and adjacent areas.

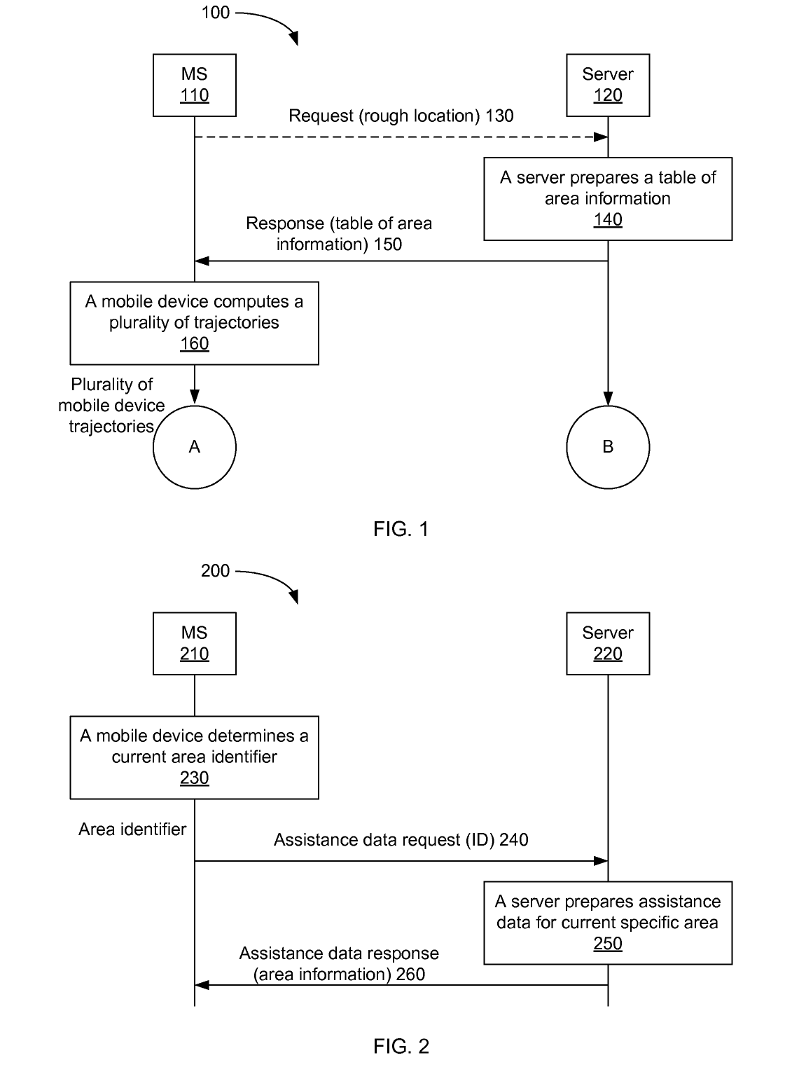

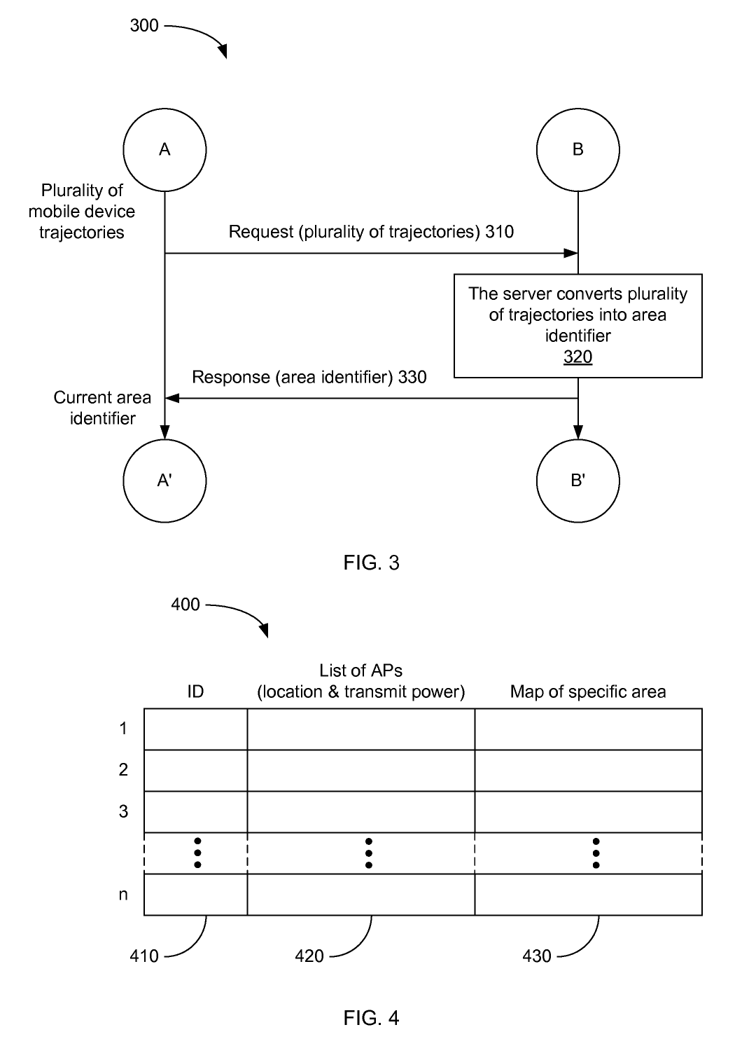

As shown in FIG. 1, a request 130 from a mobile device 110 may include a rough location of mobile device 110 such that the requested server 120 may associate the rough location with an ID, and then transmit the ID back to the mobile device 110 in a response 150. Alternatively, the server 120 prepares area information or a table of area information. The area information includes an identifier (ID), a list of access points (APs), and a map of the specific area. As shown in FIG. 2, the mobile device 110 may use the received ID in subsequent messages with a same or different server for obtaining navigation assistance data relevant to a specific area identifiable by the ID as discussed above (e.g., digital maps, locations and identifies of beacon transmitters, radio heatmaps or routeability graphs). Sometimes a map or map data includes a floor plan or floor map. Other times, a map or map data may also include a heatmap or the like.

Light-weight positioning uses a ranging model without map data. That is, only a list of APs and their respective locations and transmit powers are used to determine a range between a mobile device and each AP. In light-weight positioning, mapping data is not used by the mobile device in determining a position. Though light-weight positioning may be faster and require less bandwidth than traditional positioning, typical light-weight positioning may also have more uncertainty than traditional positioning.

Disclosed below is a novel specific area disambiguation solution based on light-weight positioning, for example, for precise indoor positioning (PIP), indoor navigation (InNav) or the like, that does not require communicating (transmitting and receiving) full map data when a server performs the method to select an area identifier. Alternatively, a mobile device performs the method to select an area identifier based on several maps from a server. Mobile device trajectories, each assuming a different specific area, are evaluated and then one is selected as the area identifier that a mobile device is currently traversing.

FIG. 1 shows a thread diagram 100 to convert a rough location into a plurality of mobile device trajectories, in accordance with some embodiments. In thread diagram 100, a mobile device 110 communicates with a server 120. First, the mobile device 110 optionally sends request 130 containing a rough location to the server 120. The rough location may be a position relative to three or more APs. Alternatively, the rough location may be an identifier of the strongest AP, for example, having the highest received power or the lowest path loss. Alternatively, the request 130 is not sent from the mobile device 110. Instead, each AP broadcasts assistance data tailored for that AP's coverage area.

At 140, the server 120 prepares an ID, area information or a table of area information. The table area information includes, for each specific area, an identifier, a list of APs and a map of the specific area. The map, for each AP in the list of APs, may include a location of the AP and/or a transmit power level of the AP. The server 120 sends and the mobile device 110 receives a table of area information in response 150.

Measurements from available APs are recorded. The AP measurements (e.g., RSSI or RTT measurements) may be recording before, during and/or after the rough location request 130 and/or before, during and/or after the response 150. The AP measurements are group together based on which identifier each AP belongs. That is, based on which APs belong to a particular identifier (as found in the list of APs), a device groups AP measurements but exclude AP measurements not found in the particular list of APs.

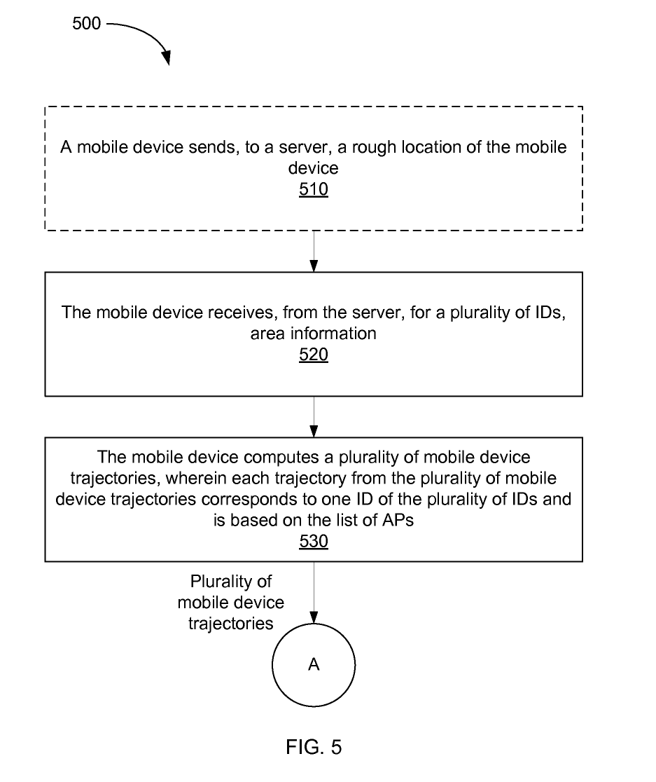

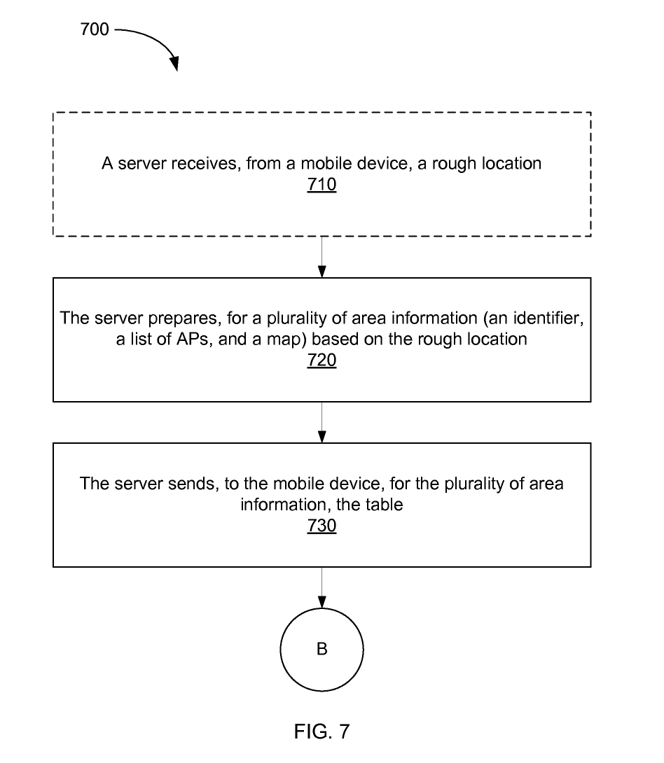

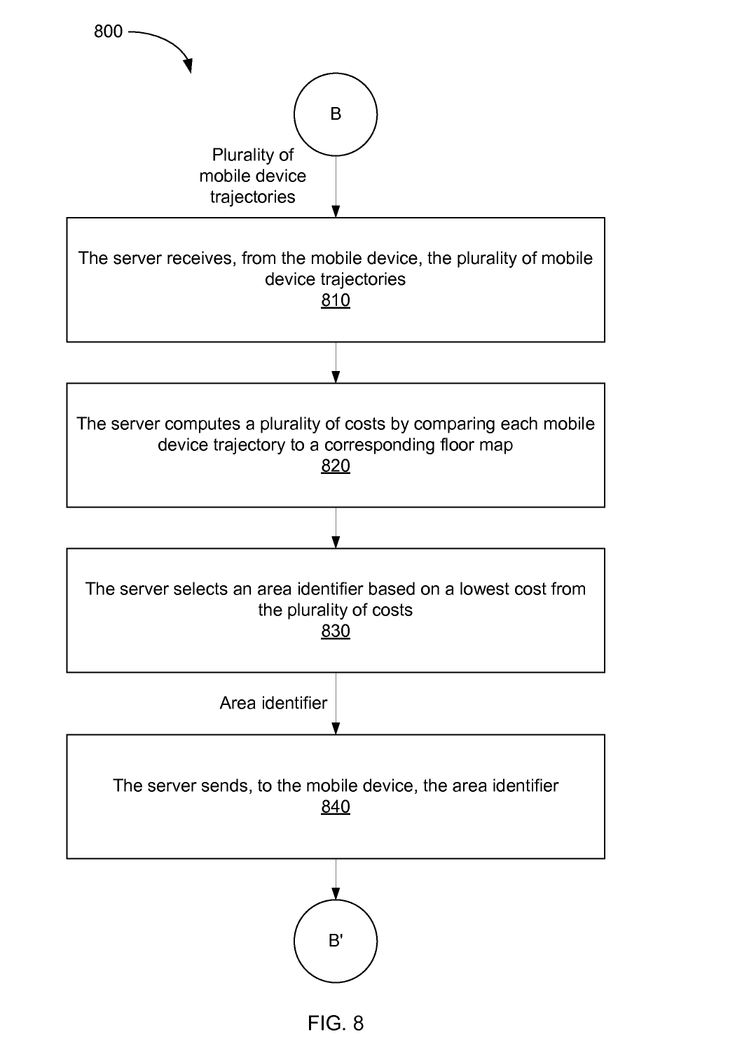

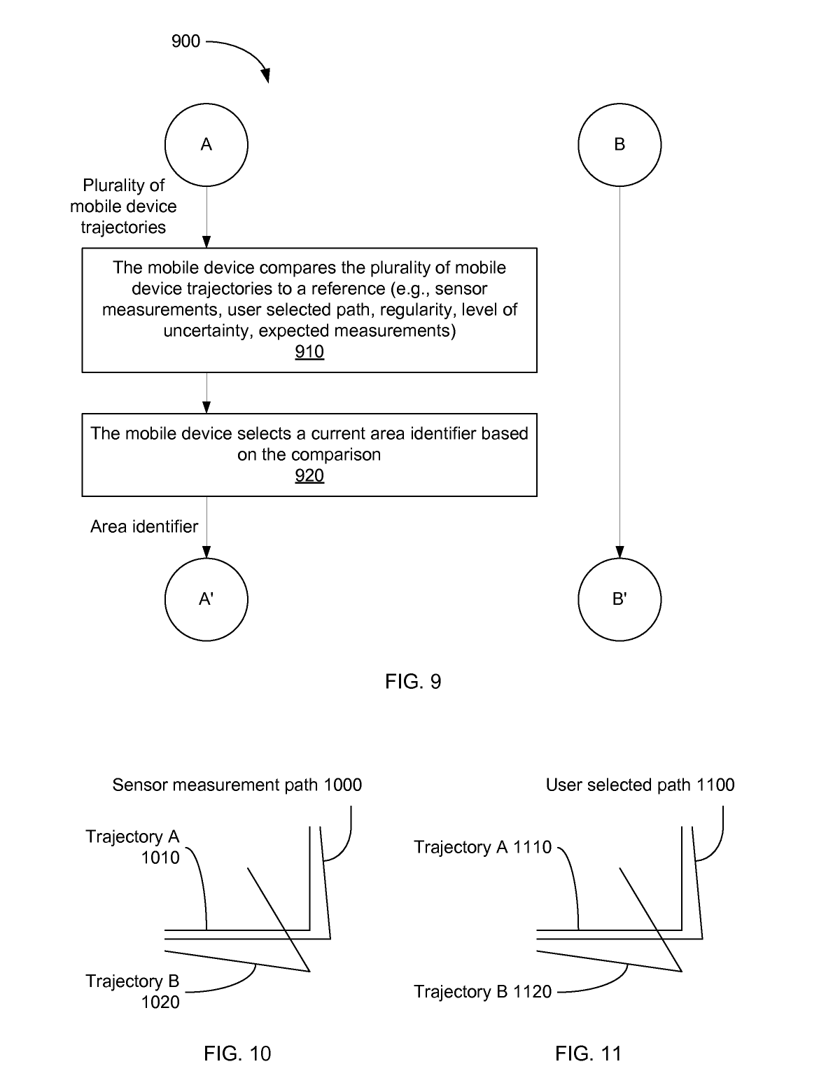

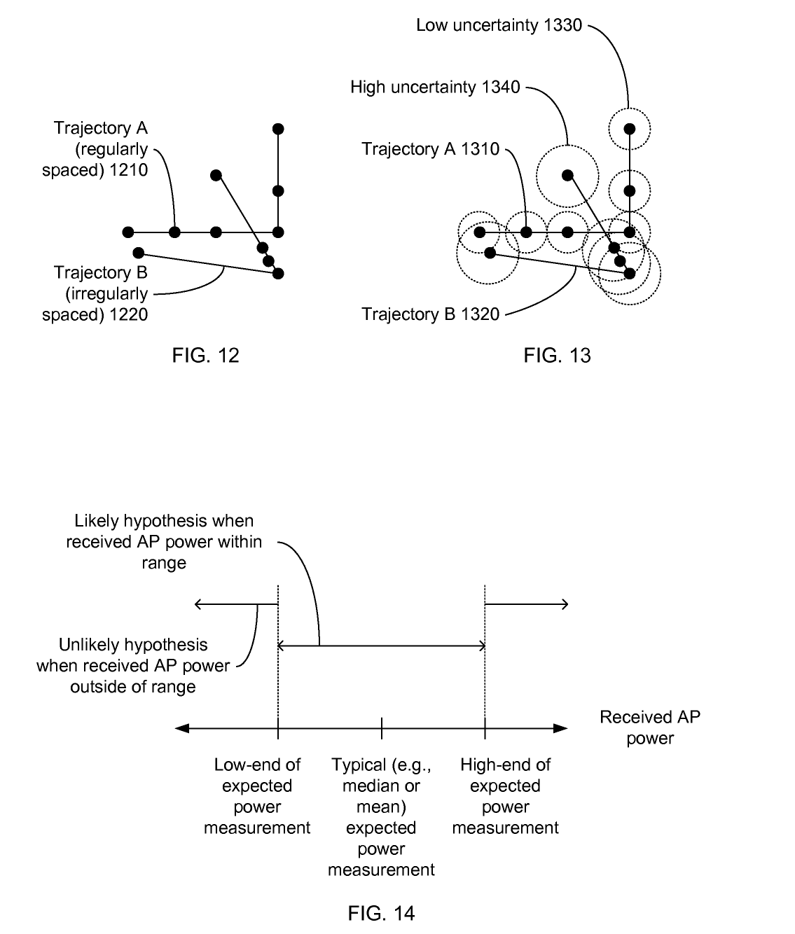

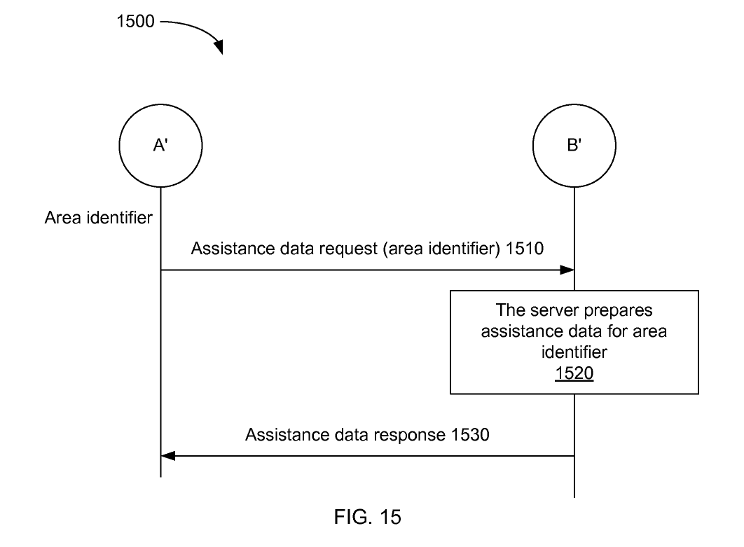

At 160, the mobile device 110 computes a plurality of mobile device trajectories based on AP measurements from only the respective list of APs. That is, one trajectory corresponds to AP measurement from just one identifier and corresponding list of APs. Each trajectory assumes a specific area. Only AP measurements from APs belong to the specific area are used to determine each particular trajectory. The plurality of mobile device trajectories is passed to marker A. Marker A from the mobile device 110 and marker B from the server 120 continues on FIG. 3, FIG. 6, FIG. 8 or FIG. 9. The thread diagram 100 is shown in more detail in FIG. 5 with respect to the mobile device 110 and in FIG. 7 with respect to the server 120.

FIG. 2 shows a thread diagram 200 to request assistance data. The thread diagram 200 shows processing between a mobile device 210 and a server 220, such as a location server. At 230, the mobile device 210 determines a current area identifier. Based on the current area identifier, the mobile device 210 sends an assistance data request 240 and the server 220 and receives an assistance data response 260. The assistance data request 240 includes the current area identifier (ID) determine at 230. At 250, in response to receiving the assistance data request 240, the server 220 prepares assistance data for the current area identifier. The server 220 then sends an assistance data response 260 to the mobile device 210. The assistance data response 260 may include area information, as described above. The assistance data response 260 is large and may contain several kilobytes to several hundred kilobyte of information.

FIG. 3 shows a thread diagram 300 to convert a plurality of mobile device trajectories into an area identifier, in accordance with some embodiments. Marker A and marker B continue from the mobile device 110 and the server 120 of FIG. 1. The mobile device 110 sends a request 310, including the plurality of mobile device trajectories, to the server 120. At 320, the server 120 converts the plurality of mobile device trajectories into an area identifier. For example, the server 120 evaluates the plurality of mobile device trajectories then selects an area identifier bases on evaluating the plurality of mobile device trajectories

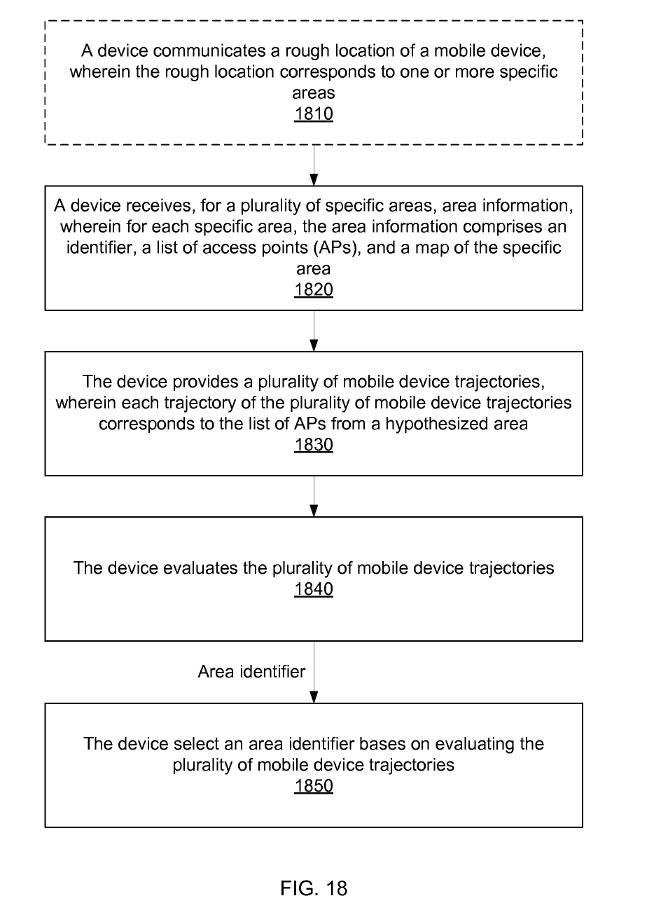

The server 120 sends the area identifier in a response 330 to the mobile device 110. FIG. 6 and FIG. 8 show the process on the mobile device 110 and the server 120, respectively, in more detail. Marker A′ and marker B′ continues on FIG. 15.

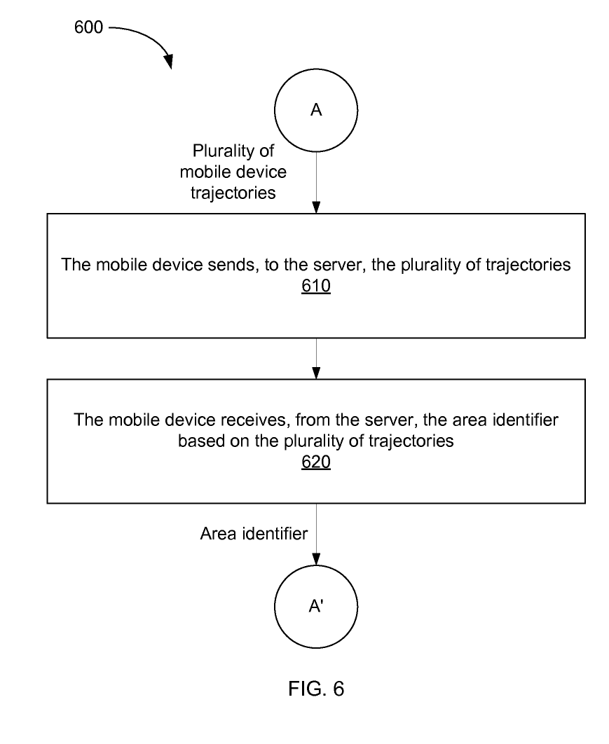

FIG. 4 shows a structure 400 of a table of area information, in accordance with some embodiments. The table of area information, for each specific area, holds an identifier (ID) 410, a corresponding list of APs 420 and a map 430 of the specific area. The map 430 is optional but is included in the table in examples below. Alternatively the table does not contain a map 430 or maps. The identifier 410 may uniquely identify an area. The corresponding list of APs 420, for each AP, may include a respective location and/or a transmit power of the AP. The list of APs 420 may include a variable number of APs.

FIG. 5 illustrates a method 500 in a mobile device 110 to obtain a plurality of mobile device trajectories, in accordance with some embodiments. At 510, a mobile device 110 optionally sends a rough location of the mobile device 110 to a server 120. At 520, the mobile device 110 receives a table of area information from the server 120. The table of area information includes, for each specific area, an identifier, a list of AP and a map for the specific area, as described above. At 530, the mobile device 110 computes a plurality of mobile device trajectories. Each trajectory of the plurality of mobile device trajectories corresponds to one ID of the plurality of IDs and is based on the corresponding list of APs. The method 500 results in a plurality of mobile device trajectories going to marker A.

FIG. 6 illustrates a method 600 in a mobile device 110 to convert a plurality of mobile device trajectories into an area identifier, in accordance with some embodiments. The method 600 begins at marker A with a plurality of mobile device trajectories. At 610, the mobile device 110 sends the plurality of mobile device trajectories to the server 120. At 620, the mobile device 110 then receives an area identifier, which is based on the plurality of mobile device trajectories, from the server 120. The method 600 ends at marker A′ with the area identifier.

FIG. 7 illustrates a method 700 in a server 120 to deliver a table of area information, in accordance with some embodiments. At 710, the server 120 optionally receives a rough location from a mobile device 110. Alternatively, the server 120 may obtain a rough location based on a location of an AP last making contact with the mobile device 110. At 720, the server 120 prepares a table of area information. The table of area information includes, for a plurality of specific areas, an identifier, a list of APs, and a map for each specific area. The table for one or more area information is based on the rough location. At 730, the server 120 sends the table of area information, for a plurality of area information, to the mobile device 110. The method 700 ends at marker B.

FIG. 8 illustrates a method 800 in a server 120 to convert a plurality of mobile device trajectories into an area identifier, in accordance with some embodiments. The method 800 begins at marker B with a plurality of mobile device trajectories. At 810, the server 120 receives the plurality of mobile device trajectories from a mobile device 110. At 820, the server 120 may compute a plurality of costs by comparing each trajectory to a corresponding floor map of each ID. For example, the server 120 applies one trajectory associated with an ID with a floor plan also associated with that ID to for a cost of that trajectory. Little or no cost is added as the trajectory passes through hallways, pathways, lobbies, doorways, and the like. Increased cost is accumulated as the trajectory passes through walls and other obstacles or traversing in an unlikely manner.

At 830, the server 220 evaluates the various costs associated with each trajectory and selects an area identifier based on a lowest cost from the plurality of costs computed at 820. If two or more LCIs have equal costs associated with the respective LCI, in some embodiments, an area identifier is selected with a higher percentage of AP signals that are obtainable by the mobile device. For example, five received signals of a possible six APs for a first ID is selected over a second ID with six received signals of a possible eight APs. In other embodiments, an area identifier is selected with fewer APs received where two or more equal costs are computed. The area identifier with fewer received APs may be more accurate that an LCI with more but weaker APs. Still in other embodiments, when two or more equal lowest cost IDs are computed, a more common or popular area identifier is selected. At 840, the server 120 sends the area identifier to the mobile device 110. The method 800 ends at marker B′.

FIG. 9 shows a thread diagram 900 to convert a plurality of mobile device trajectories into an area identifier, in accordance with some embodiments. Thread diagram 900 begins with marker A with a plurality of mobile device trajectories. In an alternative embodiment, a server 120 determines an area identifier from the plurality of mobile device trajectories (as described with reference to FIGS. 3, 6 and 8). In FIG. 9, the mobile device 110, rather than a server 120, determines the best trajectory from the plurality of mobile device trajectories and thus selects an area identifier.

At 910, the mobile device 110 compares the plurality of mobile device trajectories to a reference. The reference may be a trajectory derived from sensor measurements, for example, from an inertial sensor. The reference may be a selection of a path by a user. For example, the user may input a path being used. Alternatively, the reference may be regularity of a trajectory. An ideal trajectory is composed of equally spaced location points. Alternatively, the reference may be a level of uncertainty. An ideal trajectory is composed of low uncertainty location points. Alternatively, the reference may be an expected power level from AP measurements. For example, while somewhere within a first LCI, a certain first AP gives received power measurements across the LCI of between −60 and −90 dBm and while somewhere within a second LCI, another certain second AP gives received power measurements between −70 and −95 dBm. If a received power level of the first AP is −100 dBm (10 dB below the first range) and a second received power level of a second AP is −80 dBm (within the second range), the second LCI is more likely because the received power level is within the second range. At 920, the mobile device 110 selects an area identifier based on the comparison of 910. Thread diagram 900 ends at marker A′ with the area identifier.

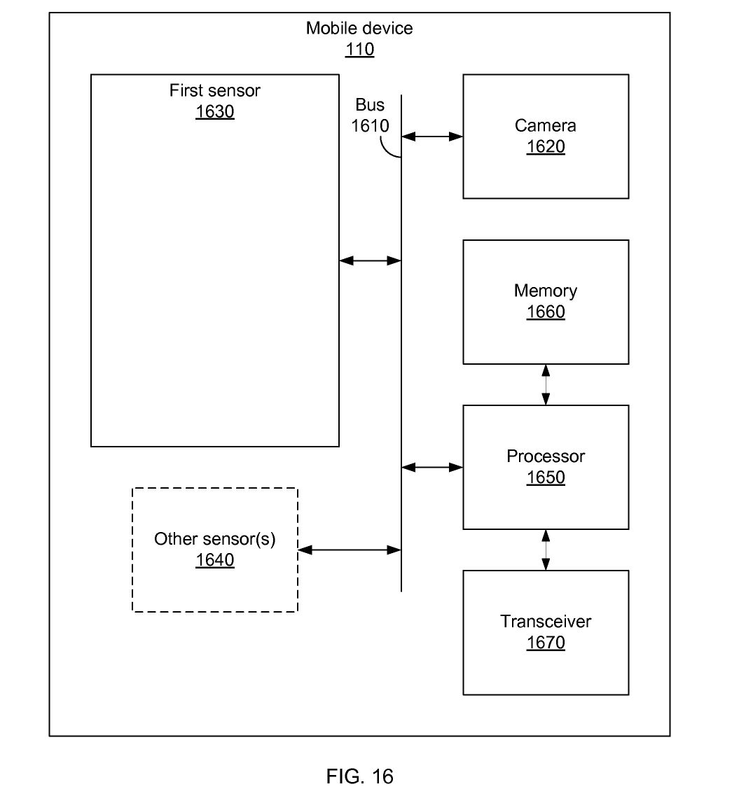

FIGS. 10-13 compare two trajectories to a reference, in accordance with some embodiments. In FIG. 10, a trajectory A 1010 (that assumes a first area identifier) is drawn together with a trajectory B 1020 (that assumes a second area identifier). These trajectories are each compared to a reference (in this case, a sensor measurement path 1000) derived from sensor measurements. The mobile device 110 selects a trajectory closest to the sensor measurement path 1000.

In FIG. 11, a trajectory A 1110 (that assumes a first area identifier) is drawn together with a trajectory B 1120 (that assumes a second area identifier). These trajectories are each compared to a reference (in this case, a user selected path 1100) selected or entered by a user. The mobile device 110 selects a trajectory closest to the user selected path 1100.

In FIG. 12, a trajectory A 1210 (that assumes a first area identifier) is drawn together with a trajectory B 1220 (that assumes a second area identifier). These trajectories are each compared to a reference (in this case, regularly spaces locations in a common direction as indicated by the locations just before and just after a location under consideration). The standard deviation of a distance between adjacent locations along a trajectory may be compared for each assumed area identifier. A number of turns may be counted in each trajectory. If a trajectory zigzags about (a high number of turns), the associated area identifier is less likely a correct area identifier. The mobile device 110 then selects a trajectory that is most regular (e.g., with the lowest standard deviation, the lowest number of turns, or the like).

In FIG. 13, a trajectory A 1310 (that assumes a first area identifier) is drawn together with a trajectory B 1320 (that assumes a second area identifier). These trajectories are each compared to a reference (in this case, low uncertainty). The mobile device 110 may select a trajectory that has the lowest overall uncertainty.

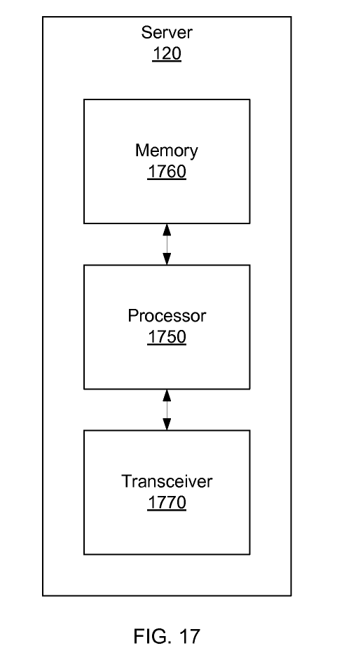

FIG. 14 charts hypotheses of various power measurements, in accordance with some embodiments. For each AP (or a representative AP or APs within a certain area), a minimum or an expected range of received power levels is provided. A received power level greater that this minimum or within this expected range indicates that the area identifier is or more likely to be the current area identifier. A received power level outside of this expected range indicates that the area identifier is not or less likely to be the current area identifier. The range for each AP may be represented by a low-end of an expected power level and a high-end of the expected power level. Alternatively, the expected power levels may be further represented by a typical (e.g., a median or a mean) expected power measurement and a standard deviation or a variance of the expected power measurement across the area identifier. When a measured received power level is within this AP power range, a hypothesis of a particular area identifier is more likely. When a measured received power level is outside this AP power range, a hypothesis of a particular area identifier is less likely.

Multiple factors may be weighed or considered when selecting a current area identifier. For example, a process may exclude area identifiers with unacceptable power levels (as shown in FIG. 14), and then select an area identifier using this subgroup of area identifiers based on uncertainty and/or regularity.

When considering a user selection, uncertainty or an expected receive power measurement, a single location rather than a trajectory may be considered. A user may tell the mobile device 110 that the mobile device 110 is positioned at an established reference point, such as an intersection of adjoining paths, at a stairway, a doorway, or the like. The assumed area identifier that results in an estimated location closest to the established reference point may be selected as the current area identifier. Alternatively, when considering uncertainty, an assumed area identifier providing the lowest uncertainty for the point may be selected. Alternatively, when considering an expected receive power measurement to various APs, the area identifier having a power measurement from an AP or group of APs belonging to an area identifier that is closest to the area identifier range may be selected.

FIG. 15 shows a thread diagram 1500 to request assistance data, in accordance with some embodiments. A mobile device 110 and a server 120 may work in cooperation to determine a current area identifier. Once the current area identifier is known, assistance data may be used to download and display a floor map to a user and more accurately determine a position of the mobile device 110. The thread diagram 1500 begins at A′ with a current area identifier. The mobile device 110 sends an assistance data request 1510, including the area identifier, to the server 120. At 1520, the server 120 prepares the requested assistance data based on the current area identifier. The server 120 sends an assistance data response 1530 to the mobile device 110. The assistance data response 1530 includes the assistance data for just associated area identifier.

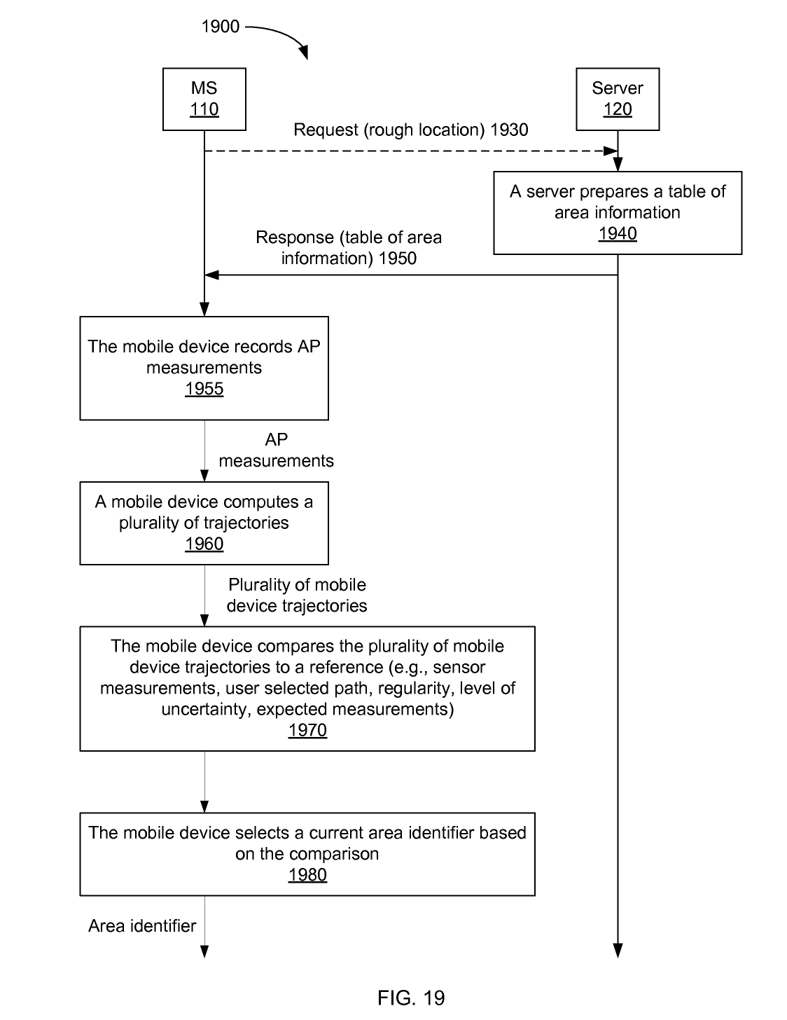

FIGS. 16 and 17 show a block diagram of a mobile device 110 and a server 120, respectively, in accordance with some embodiments. In FIG. 16, a mobile device 110 contains a bus 1610, an optical camera 1620, a first sensor 1630, other optional sensor(s) 1640 (as indicated with the dotted lines) and a processor 1650. The bus 1610 couples together the camera 1620, the first sensor 1630 and the optional sensors 1640 to the processor 1650. The other sensor(s) 1640 may include an accelerometer, a gyroscope, a light sensor, a magnetometer or a compass, a thermometer and/or the like. The mobile device 110 may also include a memory 1660 and a transceiver 1670 coupled to the bus 1610 or processor 1650. The memory 1660 may include code to perform embodiments described herein. The transceiver 1670 acts as both a receiver and a transmitter and allows the mobile device 110 to communicate with the server 120.

In FIG. 17, a server 120 includes a processor 1750, memory 1760 and a transceiver 1770. The memory 1760 may include code to perform embodiments described herein. The transceiver 1770 allows the server 120 to communicate with the mobile device 110.

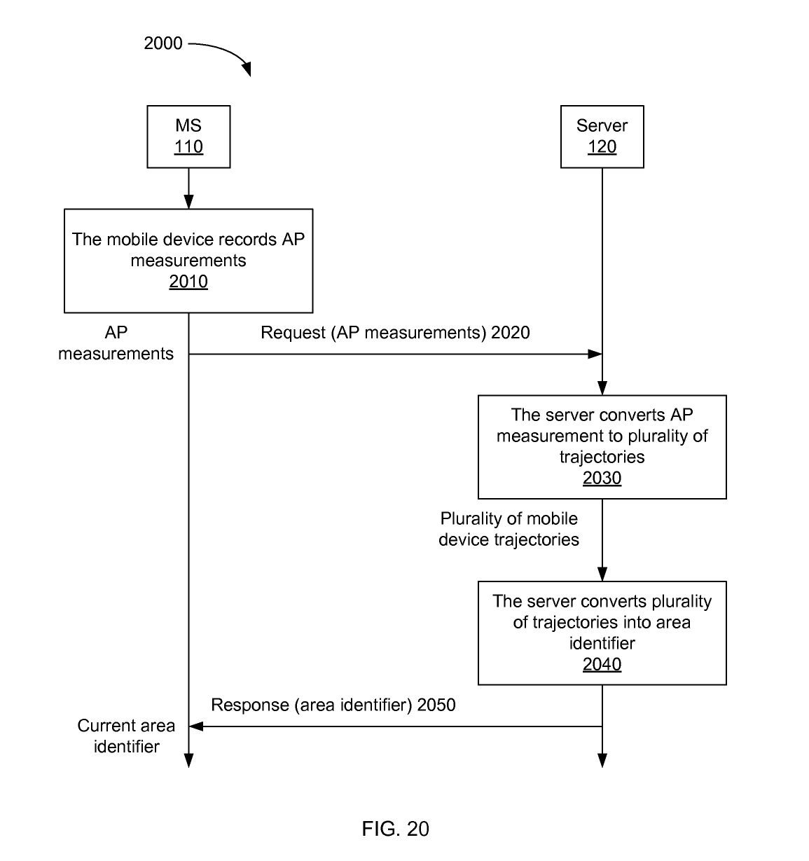

FIG. 18 shows a thread diagram, At 1810, a device optionally communicates a rough location of a mobile device, wherein the rough location corresponds to one or more specific areas.

At 1820, a device receives, for a plurality of specific areas, area information, wherein for each specific area, the area information comprises an identifier, a list of access points (APs), and a map of the specific area. A receiver may be configured to receive the area information. The map, for each specific area, is optional. The identifier, for each of the plurality of specific areas, may be an LCI (location context identifier). The area information may further include a low-end of an expected power measurement for the list of APs. The device may also include a transmitter configured to send an assistance data request including the selected area identifier. The receiver may further be configured to receive an assistance data response based on the assistance data request. The receiver and transmitter may be combined into a transceiver. The receiver acts as a means for receiving and the transmitter acts as a means for transmitting and sending.

At 1830, a device provides a plurality of mobile device trajectories, wherein each trajectory of the plurality of mobile device trajectories corresponds to the list of APs from a hypothesized area. The plurality of mobile device trajectories may be a separate trajectory for each of the plurality of specific areas. That is, the mobile device 110 may compute a separate and unique trajectory itself for each specific area. Alternatively, the plurality of mobile device trajectories may be conglomerated into a single table. AP measurements from APs in the list of APs from the plurality of specific areas may reside in this single table. The AP measurements may be RSSI (received signal strength indication) measurements or RTT (round-trip time) measurements. The plurality of mobile device trajectories is based on the AP measurements.

Generally, the device may either be a mobile device 110 or a server 120. For example, a mobile device 110 may send an assistance data request, which includes a selected area identifier and receive an assistance data response based on the assistance data request. Alternatively, the method is performed in a server 120, where providing the plurality of mobile device trajectories means receiving, at the server 120 and from a mobile device 110, the plurality of mobile device trajectories and optionally sending, from the server 120 and to the mobile device 110, the selected area identifier or assistance data based on the selected identifier. When the device is a server 129, the receiver may be further configured to receive, from the mobile device 110, the plurality of mobile device trajectories.

At 1840, a device evaluates the plurality of mobile device trajectories. The device evaluating the plurality of mobile device trajectories may comparing each of the plurality of mobile device trajectories to a trajectory from inertial sensor measurements, or may check the plurality of mobile device trajectories for regularity.

At 1850, a device selects an area identifier bases on evaluating the plurality of mobile device trajectories. The device selecting an area identifier may include a user selection or may include selecting the area identifier bases on a minimum uncertainty of the plurality of mobile device trajectories. The device evaluating the plurality of mobile device trajectories may include comparing a received power level to the low-end of an expected power measurement. A processor coupled to the receiver may be configured to provide and evaluate the plurality of mobile device trajectories, and select the area identifier. When the device is a server 129, the processor is further configured to compare the plurality of mobile device trajectories to a reference to select the area identifier. The processor may act as a means for providing, evaluating and selecting.

A non-transient computer-readable storage medium, for a device to perform hypothesis localization, may include program code stored thereon, including program code to receive, provide, evaluate and select. When the device is a mobile device 110, the program code may further include program code to send an assistance data request including the selected area identifier, and receive an assistance data response based on the assistance data request. The program code to evaluate the plurality of mobile device trajectories may comprise program code to compare each of the plurality of mobile device trajectories to a trajectory from inertial sensor measurements. The program code to evaluate the plurality of mobile device trajectories may comprise program code to check the plurality of mobile device trajectories for regularity. The program code to select the area identifier may comprise program code to select the area identifier bases on a minimum uncertainty of the plurality of mobile device trajectories. The program code to evaluate the plurality of mobile device trajectories may comprise program code to compare a received power level to the low-end of an expected power measurement.

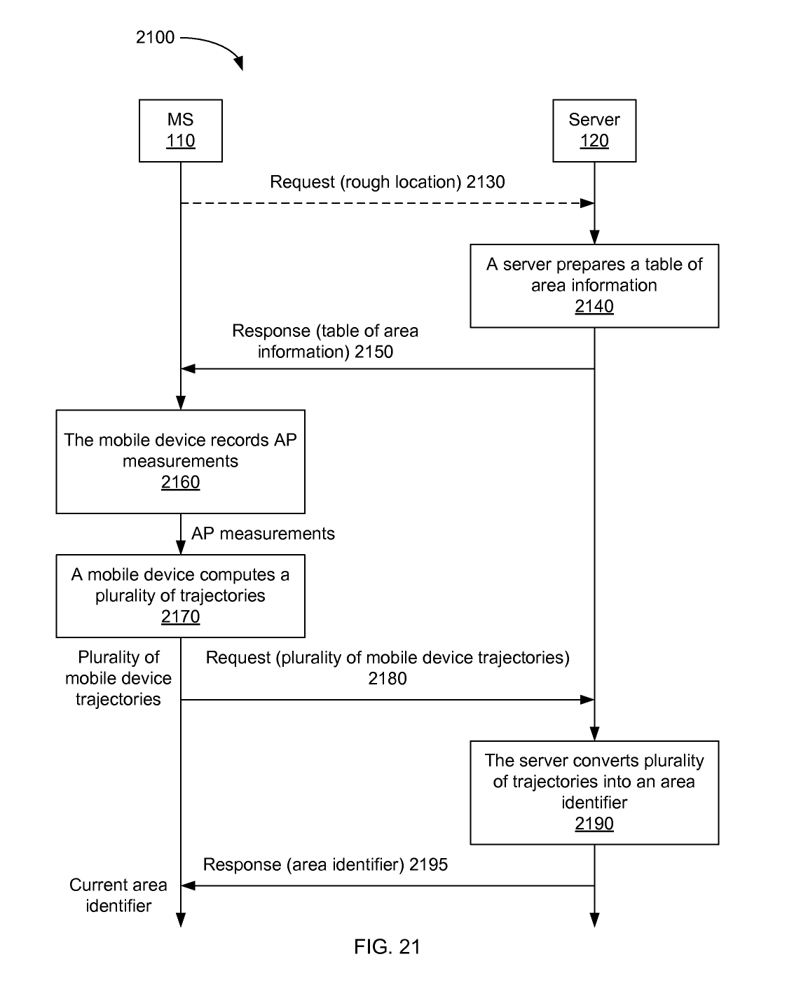

FIG. 19-21 show where a mobile device and/or a server perform methods described herein, in accordance with some embodiments.

In FIG. 19, a mobile device 110 performs the method 1900. The mobile device 110 optionally sends a request 1930, containing a rough location, to a server 120. At 1940, the server 120 prepares a table of area information based on the rough location. The server 120 sends response 1950, containing the table of area information, to the mobile device 110. In this case, the table of area information contains various maps. At 1955, the mobile device 110 records AP measurements. At 1960, the mobile device 110 computes a plurality of mobile device trajectories based on the maps and AP measurements from the respective list of APs in the respective section of the table of area information for several hypothesized specific areas. For example, if the area information for a specific area contains just four APs but several other APs are also available, the mobile device trajectory for the specific area is determined from AP measurements from the four APs and not AP measurements from the several other APs. At 1970, the mobile device 110 compares the plurality of mobile device trajectories to a reference, such as a trajectory derived from sensor measurements, a selection of a path by a user, regularity of a mobile device trajectory, a level of uncertainty, or an expected power level from AP measurements. At 1980, the mobile device 110 selects an area identifier based on the comparison.

In FIG. 20, a server 120 performs the method 2000. At 2010, a mobile device 110 records AP measurements. The AP measurements are sent from the mobile device 110 to the server 120 in request 2020. At 2030, the server 120 converts the AP measurements to a plurality of mobile device trajectories. At 2040, the server 120 converts the plurality of mobile device trajectories into an area identifier. The server 120 sends the mobile device 110 the area identifier in response 2050.

In FIG. 21, a mobile device and a server perform a hybrid method 2100. The mobile device 110 optionally sends a request 2130 containing a rough location to a server 120. At 2140, the server 120 prepares a table of area information. The server 120 sends response 2150, containing the table of area information, to the mobile device 110. In this case, the table of area information again contains various maps. At 2160, the mobile device 110 then records AP measurements. At 2170, the mobile device 110 computes a plurality of mobile device trajectories based on the maps and AP measurements from only the respective list of APs in the respective table of area information. The plurality of mobile device trajectories is sent from the mobile device 110 to the server 120 in request 2080. At 2190, the server 120 compares the plurality of mobile device trajectories to a reference and selects an area identifier based on the comparison, as described above. At 2195, the server 120 sends and the mobile device 110 receives the area identifier in response 2195.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method to perform hypothesis localization, the method comprising:
receiving, for a plurality of specific areas, area information, wherein for each specific area, the area information comprises an identifier, a list of access points (APs), and a map of the specific area;
providing a plurality of mobile device trajectories, wherein each trajectory of the plurality of mobile device trajectories corresponds to the list of APs from a hypothesized area;
evaluating the plurality of mobile device trajectories; and
selecting an area identifier bases on evaluating the plurality of mobile device trajectories.

2. The method of claim 1, wherein the identifier, for each of the plurality of specific areas, comprises an LCI (location context identifier).

3. The method of claim 1, further comprising communicating a rough location of a mobile device.

4. The method of claim 1, wherein the plurality of mobile device trajectories comprises a separate trajectory for each of the plurality of specific areas.

5. The method of claim 1, wherein the plurality of mobile device trajectories comprises AP measurements from APs in the list of APs from the plurality of specific areas.

6. The method of claim 1, wherein the plurality of mobile device trajectories is based on RSSI (received signal strength indication) measurements between a mobile device and APs in the list of APs from the plurality of specific areas.

7. The method of claim 1, wherein the plurality of mobile device trajectories is based on RTT (round-trip time) measurements between a mobile device and APs in the list of APs from the plurality of specific areas.

8. The method of claim 1, wherein the method is performed in a mobile device.

9. The method of claim 8, further comprising:
sending an assistance data request comprising the selected area identifier; and
receiving an assistance data response based on the assistance data request.

10. The method of claim 1, wherein the method is performed in a server, and wherein providing the plurality of mobile device trajectories comprises receiving, at the server and from a mobile device, the plurality of mobile device trajectories.

11. The method of claim 10, further comprising sending, from the server and to the mobile device, the selected area identifier.

12. The method of claim 10, further comprising sending, from the server and to a mobile device, assistance data based on the selected area identifier.

13. The method of claim 1, wherein evaluating the plurality of mobile device trajectories comprises comparing each of the plurality of mobile device trajectories to a trajectory from inertial sensor measurements.

14. The method of claim 1, wherein selecting an area identifier comprises a user selection.

15. The method of claim 1, wherein evaluating the plurality of mobile device trajectories comprises checking the plurality of mobile device trajectories for regularity.

16. The method of claim 1, wherein selecting the area identifier comprises selecting the area identifier bases on a minimum uncertainty of the plurality of mobile device trajectories.

17. The method of claim 1, wherein the area information further comprises a low-end of an expected power measurement for the list of APs, and wherein evaluating the plurality of mobile device trajectories comprises comparing a received power level to the low-end of an expected power measurement.

18. A device to perform hypothesis localization, the device comprising:
a receiver configured to receive, for a plurality of specific areas, area information, wherein for each specific area, the area information comprises an identifier, a list of access points (APs), and a map of the specific area; and
a processor coupled to the receiver, wherein the processor is configured to:
provide a plurality of mobile device trajectories, wherein each trajectory of the plurality of mobile device trajectories corresponds to the list of APs from a hypothesized area;
evaluate the plurality of mobile device trajectories; and
select an area identifier bases on evaluating the plurality of mobile device trajectories.

19. The device of claim 18, further comprising
a transmitter configured to send an assistance data request comprising the selected area identifier;
wherein the receiver is further configured to receive an assistance data response based on the assistance data request.

20. The device of claim 18, wherein the device comprises a server, and wherein the receiver is further configured to receive, from a mobile device, the plurality of mobile device trajectories.

21. The device of claim 18, wherein the processor is further configured to compare the plurality of mobile device trajectories to a reference to select the area identifier.

22. A device to perform hypothesis localization, the device comprising:
means for receiving, for a plurality of specific areas, area information, wherein for each specific area, the area information comprises an identifier, a list of access points (APs), and a map of the specific area;
means for providing a plurality of mobile device trajectories, wherein each trajectory of the plurality of mobile device trajectories corresponds to the list of APs from a hypothesized area;
means for evaluating the plurality of mobile device trajectories; and
means for selecting an area identifier bases on evaluating the plurality of mobile device trajectories.

23. The device of claim 22, further comprising:
means for sending an assistance data request comprising the selected area identifier;
wherein the means for receiving comprises means for receiving an assistance data response based on the assistance data request; and
wherein the device comprises a mobile device.

24. The device of claim 22, wherein the means for providing the plurality of mobile device trajectories comprises means for receiving, from a mobile device, the plurality of mobile device trajectories, and wherein the device comprises a server.

25. A non-transient computer-readable storage medium, for a device to perform hypothesis localization, including program code stored thereon, comprising program code to:
receive, for a plurality of specific areas, area information, wherein for each specific area, the area information comprises an identifier, a list of access points (APs), and a map of the specific area;
provide a plurality of mobile device trajectories, wherein each trajectory of the plurality of mobile device trajectories corresponds to the list of APs from a hypothesized area;
evaluate the plurality of mobile device trajectories; and
select an area identifier bases on evaluating the plurality of mobile device trajectories.

26. The non-transient computer-readable storage medium of claim 25, wherein the program code further include program code to:
send an assistance data request comprising the selected area identifier; and
receive an assistance data response based on the assistance data request;
wherein the device comprises a mobile device.

27. The non-transient computer-readable storage medium of claim 25, wherein the program code to evaluate the plurality of mobile device trajectories comprises program code to compare each of the plurality of mobile device trajectories to a trajectory from inertial sensor measurements.

28. The non-transient computer-readable storage medium of claim 25, wherein the program code to evaluate the plurality of mobile device trajectories comprises program code to check the plurality of mobile device trajectories for regularity.

29. The non-transient computer-readable storage medium of claim 25, wherein the program code to select the area identifier comprises program code to select the area identifier bases on a minimum uncertainty of the plurality of mobile device trajectories.

30. The non-transient computer-readable storage medium of claim 25, wherein the area information further comprises a low-end of an expected power measurement for the list of APs, and wherein the program code to evaluate the plurality of mobile device trajectories comprises program code to compare a received power level to the low-end of an expected power measurement.
